(19) United States
(12) Patent Application Publication
(10) Pub. No.: US 2009/0076836 A1
(43) Pub. Date: Mar. 19, 2009

(54) SYSTEMS, METHODS, SOFTWARE AND INTERFACES FOR REPORTING RESULTS DERIVED FROM JURY VERDICT SUMMARY CONTENT, COURT DOCUMENTS AND OTHER ANALYTICAL AND LITIGATION MATERIALS

(76) Inventors: Jeff Arvidson, Eagan, MN (US); Constance Hall, Lester Prairie, MN (US)

Correspondence Address: SCHWEGMAN, LUNDBERG & WOESSNER, P.A., P.O. BOX 2938, MINNEAPOLIS, MN, 55402, US

(21) Appl. No.: 12/188,117

(22) Filed: Aug. 7, 2008

Related U.S. Application Data
(60) Provisional application No. 60/963,717, filed on Aug. 7, 2007.

(51) Int. Cl. G06Q 50/00; G06F 17/30

(52) U.S. Cl. 705/1; 707/3; 707/E17.014

(57) ABSTRACT

The present inventors devised, among other things, an online legal research system that allows users to generate a report interface that not only summarizes key pieces of information, such as verdict information, but also enables access to related trending and statistical information as well as additional litigation, analytical, and expert materials. The exemplary system generates a dynamic verdict report based on parameters selected from a query-definition template having an embedded taxonomy.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. The following notice applies to this document: Copyright © 2007, Thomson Reuters Global Resources.

### RELATED APPLICATION

The present application claims priority to U.S. Provisional Application 60/963,717, which was filed on Aug. 7, 2007. This application is incorporated herein by reference.

### TECHNICAL FIELD

Various embodiments of the invention relate to case law evaluation and, more particularly, to a system and method for selecting query parameters, retrieving a set of documents based on the selected query parameters, and generating a report interface that summarizes and provides access to verdict information.

### BACKGROUND

One problem recognized by the present inventors concerns usage of verdicts. Specifically, lawyers, paralegals and legal assistants use verdicts—that is, damage awards in past legal disputes—to determine or gauge the value of a legal dispute, to identify experts, and to obtain information about judges and attorneys. The specific problem is that conventional legal research tools require users to define Boolean keyword or natural langue queries, and manually sift through the search results to identify verdict information.

Accordingly, the present inventors recognized an unmet need for more effective and efficient ways of researching verdict information.

### SUMMARY

To address this and/or other needs, the present inventors devised, among other things, an online legal research system that generate web-based report interfaces that not only summarize and facilitate access to verdict information, but also provide trending information and links to additional litigation, analytical, and expert materials.

The exemplary system generate a dynamic verdict report based on parameters selected from a query-definition interface having one or more embedded taxonomies. Exemplary parameters include injury type, case type, jurisdiction, and date range information. Users also have the option to focus search results on a specific product or company as well as particular key words. Fielded elements within jury verdict databases along with full-text queries are used to generate an interface that includes trending information on the selected parameters. Additional litigation-assessment information, such as experts, expert comparison, expert testimony if available, and medical illustrations and information, is also automatically retrieved.

### BRIEF DESCRIPTION OF THE DRAWINGS

FIG. 1 is a flowchart of an exemplary method of operating a web-based case law evaluator, which corresponds to various embodiments of the present invention.

FIG. 2 is a facsimile of an exemplary State Litigation tab interface which corresponds to various embodiments of the present invention.

FIG. 3 is a facsimile of an exemplary Links For tab interface which corresponds to various embodiments of the present invention.

FIG. 4 is a facsimile of an exemplary jurisdiction parameter tab interface corresponding to various embodiments of the present invention.

FIG. 5 is a facsimile of an exemplary case type parameter tab interface corresponding to various embodiments of the present invention.

FIG. 6 is a facsimile of an exemplary personal injury type parameter tab interface corresponding to various embodiments of the present invention.

FIG. 7 is a facsimile of an exemplary injury type parameter tab interface corresponding to various embodiments of the present invention.

FIG. 8 is a facsimile of an exemplary damages type parameter tab corresponding to various embodiments of the present invention.

FIG. 9 is a facsimile of an exemplary company type parameter tab interface corresponding to various embodiments of the present invention.

FIG. 10 is a facsimile of an exemplary industry type parameter tab interface corresponding to various embodiments of the present invention.

FIG. 11 is a facsimile of an exemplary report components checkboxes interface corresponding to various embodiments of the present invention.

FIG. 12 is a facsimile of an exemplary awards- by-county element corresponding to various embodiments of the present invention.

FIG. 13 is a facsimile of an exemplary citation list interface corresponding to various embodiments of the present invention.

FIG. 14 is a facsimile of an exemplary awards-by-party element corresponding to various embodiments of the present invention.

FIG. 15 is a facsimile of an exemplary citation list interface corresponding to various embodiments of the present invention.

FIG. 16 is a facsimile of an exemplary largest- rewards element corresponding to various embodiments of the present invention.

FIG. 17 is a facsimile of an exemplary awards-amount analysis element corresponding to various embodiments of the present invention.

FIG. 18 is a facsimile of an exemplary jury-verdict summaries element corresponding to various embodiments of the present invention.

FIG. 19 is a facsimile of an exemplary jury verdict summaries element having a More Jury Verdicts link and corresponding to various embodiments of the present invention.

FIG. 20 is a facsimile of an exemplary trial court memoranda element corresponding to various embodiments of the present invention.

FIG. 21 is a facsimile of an exemplary appellate court documents element corresponding to various embodiments of the present invention.

FIG. 22 is a facsimile of an exemplary appellate decisions element corresponding to various embodiments of the present invention.

FIG. 23 is a facsimile of an exemplary medical resources report interface corresponding to various embodiments of the present invention.

FIG. 24 is a facsimile of an exemplary medical illustrations report interface corresponding to various embodiments of the present invention.

FIG. 25 is a facsimile of an exemplary expertise distribution report interface corresponding to various embodiments of the present invention.

FIG. 26 is a facsimile of an exemplary “experts by expertise” report interface corresponding to various embodiments of the present invention.

FIG. 27 is a facsimile of an exemplary expert comparison interface corresponding to various embodiments of the present invention.

FIG. 28 is a facsimile of an exemplary expert case listing interface corresponding to various embodiments of the present invention.

FIG. 29 is a facsimile of an exemplary expert testimony excerpts interface corresponding to various embodiments of the present invention.

FIG. 30 is a facsimile of an exemplary print interface corresponding to various embodiments of the present invention.

FIG. 31 is a facsimile of an exemplary printer settings interface corresponding to various embodiments of the present invention.

FIG. 32 is a facsimile of an exemplary download interface corresponding to various embodiments of the present invention.

FIG. 33 is a facsimile of an exemplary download settings interface corresponding to various embodiments of the present invention.

FIG. 34 is a facsimile of an exemplary fax interface corresponding to various embodiments of the present invention.

FIG. 35 is facsimile of an exemplary fax settings interface corresponding to various embodiments of the present invention.

FIG. 36 is a facsimile of an exemplary email interface corresponding to various embodiments of the present invention.

FIG. 37 is a facsimile of an exemplary email settings interface corresponding to various embodiments of the present invention.

FIG. 38(X) is an exemplary online legal research or information-retrieval system which incorporate the interfaces and related functionality described herein and which therefore corresponds to various embodiments of the present invention.

### DETAILED DESCRIPTION OF THE EXEMPLARY EMBODIMENT(S)

This description, which incorporates the figures and appended claims, describes one or more specific embodiments of an invention. These embodiments, offered not to limit but only to exemplify and teach the invention, are shown and described in sufficient detail to enable those skilled in the art to implement or practice the invention. Thus, where appropriate to avoid obscuring the invention, the description may omit certain information known to those of skill in the art.

### Exemplary Methods of Operation

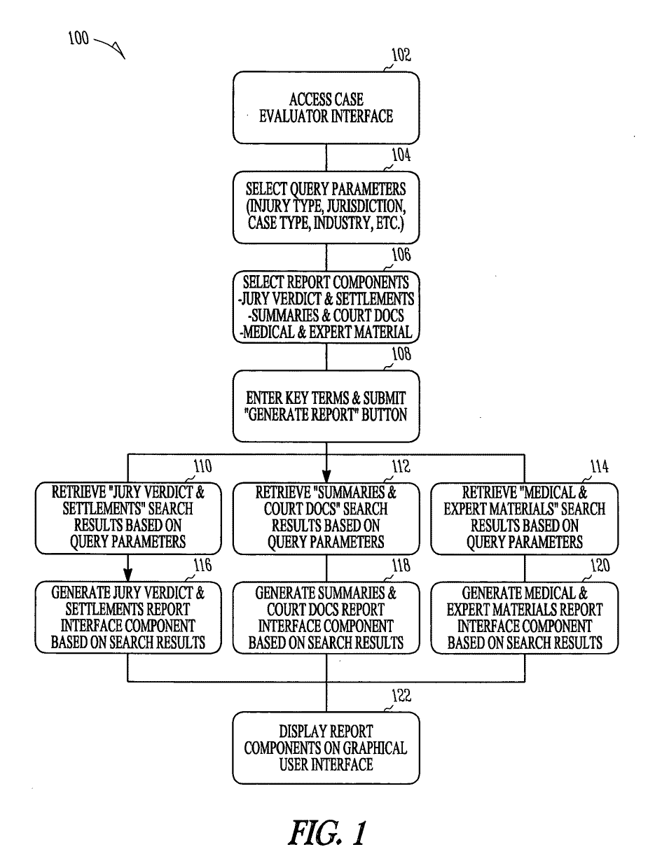

FIG. 1 shows a flowchart depicting an exemplary method 100 of operating a case law evaluator portion an information-retrieval system. The flowchart includes blocks 102-122, which are arranged and described serially and/or in parallel. However, this arrangement is not necessarily restrictive of the invention; indeed, other embodiments may execute two or more serially arranged blocks in parallel or parallel-arranged blocks in serial fashion. Other embodiments also alter the process sequence or provide different functional partitions or blocks to achieve analogous results. Moreover, still other embodiments implement the blocks as two or more interconnected hardware modules with related control and data signals communicated between and through the modules. Thus, the exemplary process flow applies to software, hardware, and firmware implementations.

The exemplary method begins at block 102, which entails a user accessing a case law evaluator portion of an information retrieval system. In the exemplary embodiment, this entails a user accessing the case law evaluator via a client access device, inputting login credentials, and if authenticated, accessing the case law evaluator. In block 104, the user selects query parameters from a series of templates or tabs in a query-definition interface. These query parameters include jurisdiction, injury type, case type, damages, company, and industry. The query parameters are not required however. In block 106, the user selects report interface components. The report components include jury verdict and settlements, summaries and court documents, and medical and expert material. In the exemplary embodiment, the user must choose at least one component before submitting the “Generate Report” command as indicated in block 108. The query is submitted and the information for the report components and elements is retrieved as indicated via blocks 110, 112, and 114. With the information gathered, each report interface is generated and displayed on the client access device for the user as indicated via blocks 116, 118, 120, and 122.

### Access to Case Evaluator

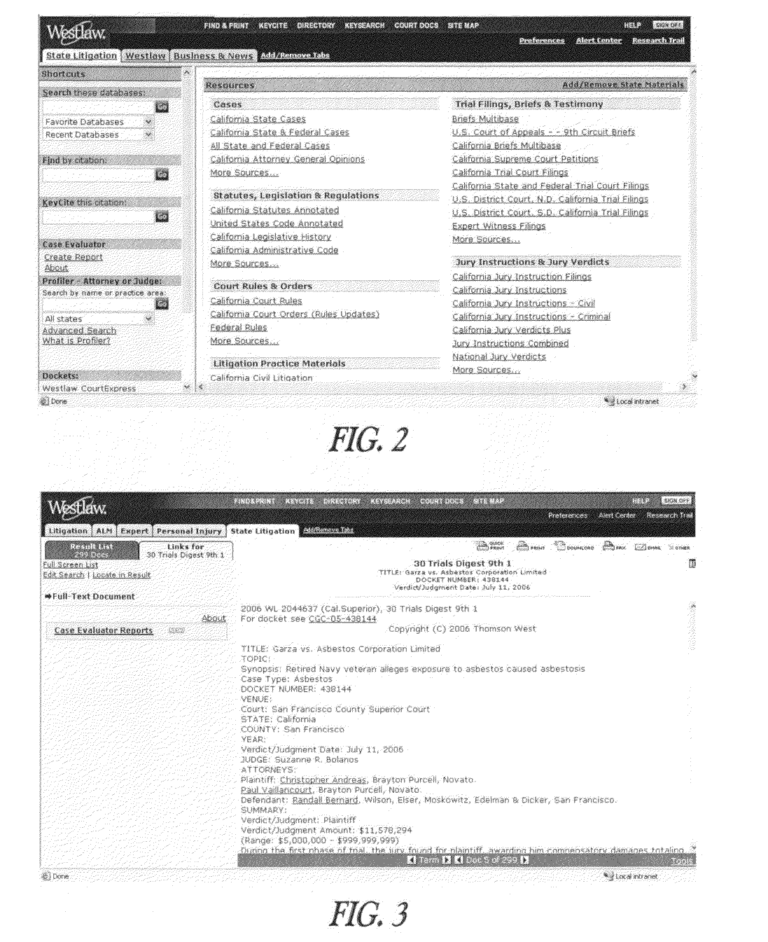

FIG. 2 shows an exemplary interface portion of an information retrieval system, which provides access to case evaluator. A user accesses a shortcut on the left frame of the Litigation, State, and State Litigation tabs. In addition, FIG. 3 depicts another exemplary interface within the information retrieval system, which provides access to the case evaluator research interface. A user accesses a shortcut on the left frame of the Links For tabs for jury verdict summaries. However users can request a report from a number of locations including ProLaw®, FindLaw® and an ASP site.

### Selection of Query Parameters and Report Components

FIG. 4 shows an exemplary jurisdiction type tab parameter interface 400. A “select jurisdiction” box 410, on the left-hand side of the interface, lists a taxonomy or hierarchical set of jurisdictions available for searching, with corresponding checkboxes. If national is selected, all available jury verdict summaries for all jurisdictions are included in the report. All selected Jurisdictions are populated to the “Limit Search to These Areas” box or region 420 on the right-hand side of the tab template upon user selection of an acceptance feature, such as command button 430. If there is no jurisdiction chosen, the default is national. Jurisdiction is not a required field. In addition, the user can input the key terms for the query in an input box 440 below Select Jurisdiction box 410. Note the user has the option to input or change the key terms at each tab in the query parameter selection process. In some embodiment, the user may have a set of preferred or frequently used key terms stored in association with his user credentials or account information; these may be displayed as a pick list or anticipated by use of an auto-complete function.

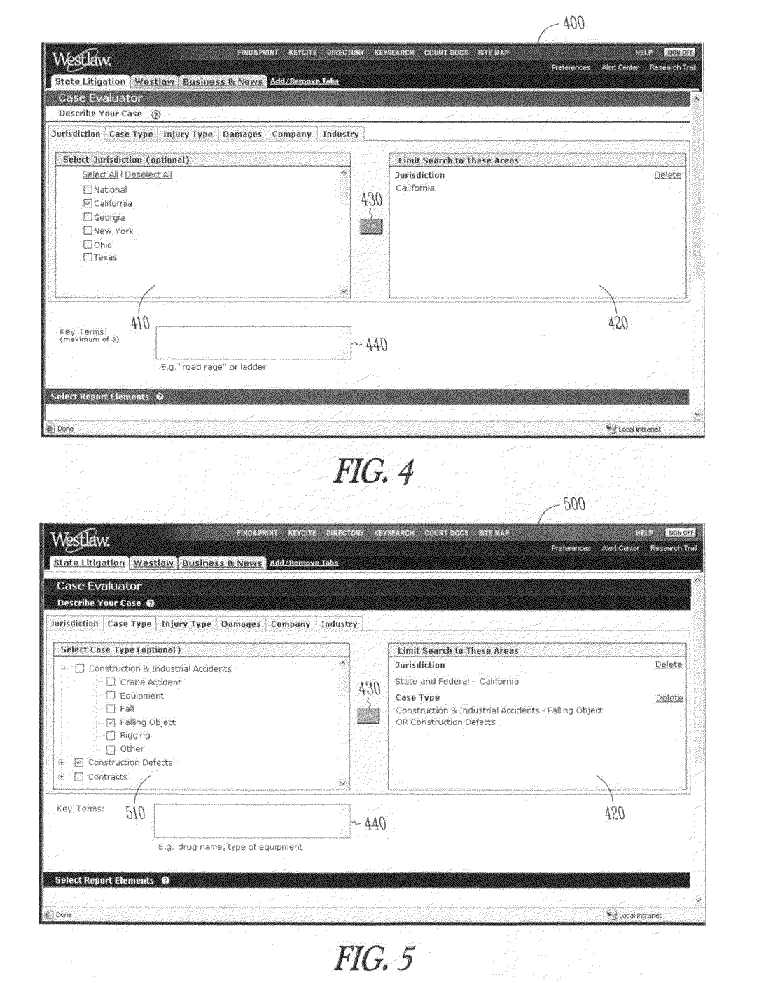

FIG. 5 shows the case type tab parameter interface 500. Case types are listed in a left-hand box 510 of the tab template in alphabetical order and in a tree format. If no selection is made, all case types are included in the report parameters. Case Type is not a required field. Multiple case types may be selected by checking the appropriate checkboxes and are searched with an OR connector. All selected case types are populated in the Limit Search box on the right-hand side of the tab template.

The injury type tab parameter contains both a “Personal Injury” search tab and an “Other Injury” tab within the “Select Injury Type” box. Users may not select injuries from both the personal injury and non-medical injury templates. When the user selects an injury from one template, the other template turns gray and the user is prevented from selecting injuries from that template. If no injury selection is made, all injury types are included in the report parameters. Multiple injury types (to a maximum of 3) may be selected by checking the appropriate checkboxes and searched with an OR connector. All preferred terms for selected injury types are populated in the Limit Search to These Areas box on the right-hand side of the tab template when the user clicks the Add button. Injury type is not a required field.

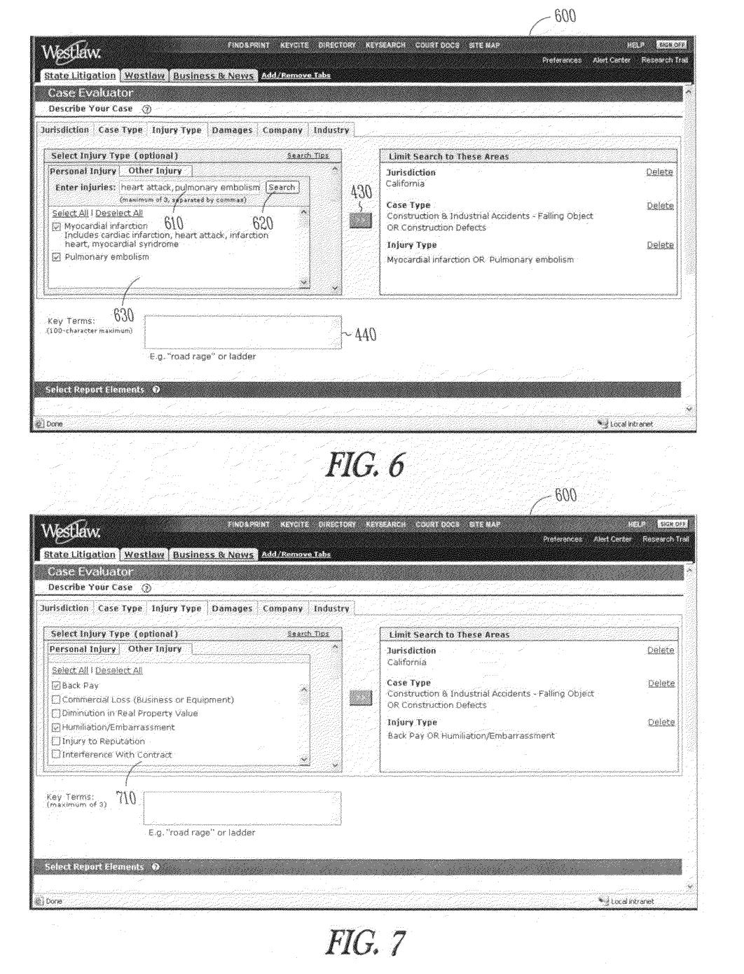

FIG. 6 shows an exemplary personal injury type tab parameter interface 600 that allows the user to search for personal injuries by entering a desired term into a search box 610. A message is displayed in the blank tab for the user to enter text in text field above and click “Search” button 620 The user may enter multiple search terms into the personal injury template. The user's personal injury term search returns the highest ranked, preferred term(s) in the taxonomy that match the user's search term(s) and displays in alphabetical order. The terms are displayed in a box 630 along with a checkbox to the left of each term. The first items in the box are “Select All/Deselect All” links. The user may select one, multiple, or all the personal injury preferred terms and promote them to the Limit Search box by checking the desired boxes and clicking the Add button.

FIG. 7 shows the “other injury” tab parameter interface part of interface 600 that contains a box 710 with a discrete list of non-medical injury types with checkboxes to the left of each term. The first items in the box described in the non-medical injury box are “Select All/Deselect All” links. Users select one, multiple, or all terms of the other injury terms and promote them to the Limit Search box by checking the desired boxes and clicking the Add button.

FIG. 8 shows an exemplary damages tab parameter interface 800 with a menu or box 810 listing the verdict dollar amounts. If no selection is made, all damage ranges are included in the report parameters. The user may select multiple damage ranges. The selected damages populate in Limit Search to These Areas box 420 on the right-hand side of the tab template. Damages is not a required field.

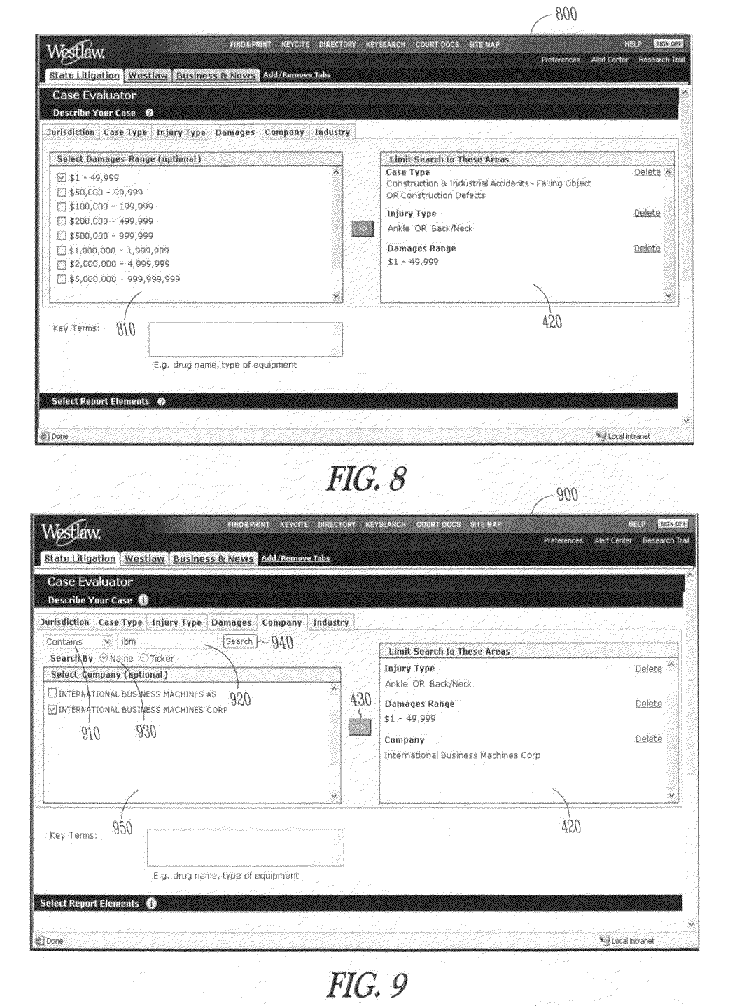

FIG. 9 shows an exemplary company tab parameter interface 900 that allows the user to search for a company name (e.g. IBM). The company tab search functionality allows the user to 1) select either Contains (default), Begins With, or Exact Phrase from a pull-down menu 910; 2) type in a term or ticker in box 920; and 3) click a “Search” radio button 930 to search for company names meeting the search criteria. In a Select Company box 940 appears the following: Enter text in text field above and click “Search” (not shown in this view.) After selection of search command button 940, the results of the user's query populate box or region 950 of the company tab, with corresponding checkboxes. The user selects one or more company names from the result list and they are searched with an OR connector. The selected company names populate in the Limit Search to These Areas box on the right-hand side of the tab template when the user adds it using the double-arrow Add button 430. If no results are retrieved for the user's query, a message indicating no matches were found displays in box 950. Company is not a required field.

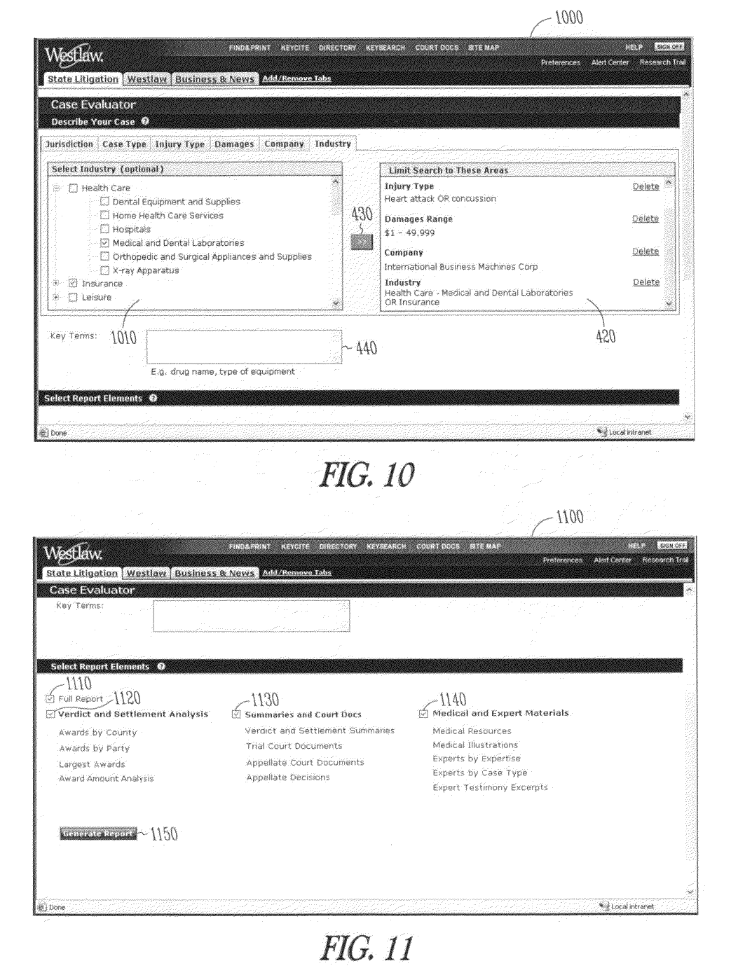

FIG. 10 shows an exemplary industry tab parameter interface 1000 that allows the user to select an industry (e.g. Transportation) from a taxonomy tree listing within a box or region 1010. The user selects one or more industry names from the list, at the node and/or subnode level, and they are searched with an OR connector. The selected industry names promote to “Limit Search to These Areas” box 420 on the right-hand side of the tab template when the user clicks the Add button 430. Industry is not a required field.

Key terms box 440 enables the user to input additional terms to limit the report. The exemplary embodiment allows a maximum of 100 characters for box 440. The terms add to the Terms and Connectors search on the applicable jury verdict, trial court memoranda, briefs, and appellate case law content. There are “OR” connectors between each key term. Key terms is not a required field. The search query uses “OR” connectors between each selected limitation within a tab and “AND” connectors between tabs, including the set of terms included in the key terms box. (Some embodiments include features that allows users to save or record the query defined in box 420 for later use by the user on a manual basis and/or alternatively to establish an alert that automatically runs the verdict related query periodically and provides the results via email, SMS, fax, snail mail, etc.)

FIG. 11 shows an exemplary report-options interface 1100 which allows uses to select report options for search results. There are four checkbox selections under the Select Report Elements heading including Full Report 1110, Verdict and Settlement Trends 1120, Summaries and Court Documents 1130, and Medical and Expert Materials 1140, with Full Report 1110 selected by default. (some embodiments allows users to define and store the default report option as a user preference.) If the Full Report checkbox is selected, all checkboxes are selected and if it is deselected, all checkboxes are cleared. Any combination of the three report components may be selected. The elements contained in each report component are listed under the component name without checkboxes in this order: Jury Verdicts and Settlement Trends contains Awards by County, Awards by Party, Largest Awards, and Award Amount Analysis; Summaries and Court Documents contains Verdict and Settlement Summaries, Trial Court Documents, Appellate Court Documents, and Appellate Decisions; Medical and Expert Materials contains Medical Resources, Medical Illustrations, Expertise Distribution, Experts by Case Type, and Expert Testimony Excerpts. Some embodiment allow greater specificity in report generation by including check boxes for the contents of the each of the three major report types. In one such embodiment, it would therefore be possible for a user to Awards by County, Verdict and Settlement Summaries, and Expert Testimony Excerpts.

A “Generate Report” button 1150 displays at the bottom of the template. Clicking “Generate Report” button 1150 generates the report using the parameters selected in the template.

### Functionality of Jury Verdict and Settlement Trend Analysis Report Component

### Awards by County Element

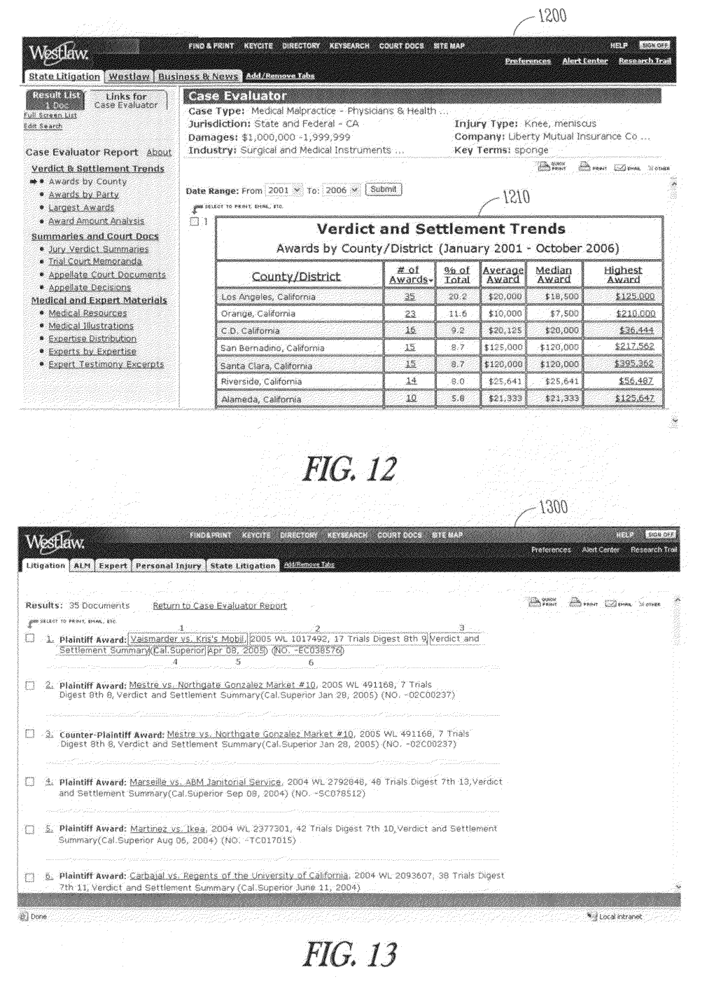

FIG. 12 shows an exemplary Awards by County report interface 1200, which includes table 1210. The table lists all counties (and/or federal districts) within the selected jurisdiction(s) for which there is at least one jury verdict summary, including $0 awards. The table heading states “Verdicts and Settlement Trends, Awards by County/District.”

If more than one state is included, the state name follows the county name, separated by a comma; however, it is acceptable to display the state name at all times without regard to the number of jurisdictions included in the report. If one or more federal district courts are included, they are listed with the district abbreviated and the full state name. The list defaults to a sort by number of cases within the county/district, with the highest number first and secondary sorting by county/district in ascending alphabetical order. The user may sort by each column in the Awards by County table (ascending or descending) by clicking on the column heading, according to the following rules: a) Sort by county/district in alpha order with secondary sort of # of cases from highest to lowest; b) Sort by % of total with secondary sort by county/district name in ascending alpha order; c) Sort by Average Award with secondary sort by county/district name in ascending alpha order; d) Sort by Median Award with secondary sort by county/district name in ascending alpha order; e) Sort by Highest Award with secondary sort by county/district name in ascending alpha order. The list displays no more than the top 10 counties and/or federal districts. If more than 10 counties or federal districts have results to display, all remaining results are combined into an “Other” category and displayed in the last row of the table. Additional jurisdictions are listed separately so that the Other category does not exceed 20% of the total. The “Other” row always sorts below the rows containing major elements. The table contains columns for county/district name, # of Awards, % of Total, Average Award, Median Award, and Highest Award.

For purposes of all calculations in the report, the following criteria apply: a) multiple awards to different plaintiffs are added together to determine the total award amount; b) if awards are made to both the plaintiff and the defendant, each award is counted separately; however, when a case has both a claim and a counterclaim and only one side receives a dollar award, the case only counts once; c) if one side is awarded court costs or other fees or expenses, the costs and fees should not be calculated into the total award (award is before any positive or negative modifications by the court); d) non-monetary awards that are not associated with a dollar value are assigned a value other than 0 and are excluded from the statistical reports but may be included as excerpts; e) confidential or private settlements with no given award amounts are assigned a value other than 0 and are excluded from the statistical reports but may be included as excerpts. The % of Total is calculated using the number of cases for the county/district and the total number of cases for all counties/districts. The Highest Award is determined using the numerical values in the award amount fields of the jury verdict summaries before any modifications by the court. The Average and Median award amounts are calculated using the numerical values in the award amount fields of the jury verdict summaries.

Some embodiments include deduplication technology to prevent double counting of verdict data from the same case that may appear in multiple verdict summary documents, news articles, or caselaw document. See, for example, co-pending U.S. patent application Ser. No. 11/122,577, which was filed on May 5, 2005 and which is incorporated herein by reference. Some embodiment associate a unique case identifier with each verdict summary to facilitate deduplication by simply ensuring that the same case identifier is not associated with more than one verdict amount

FIG. 13 shows the # of Awards entries in table 1210 are hyperlinked such that a result list of all of the summaries included in the # of Awards display in a new window 1300. The highest award values are hyperlinked such that a result list of summaries equaling the highest award value(s) displays in a new window. The cite list lists all awards such that the number of documents in the cite list matches the number in the associated # of Awards cell and identifies awards by either Plaintiff or Counter-Plaintiff labels.

### Awards by Party Element

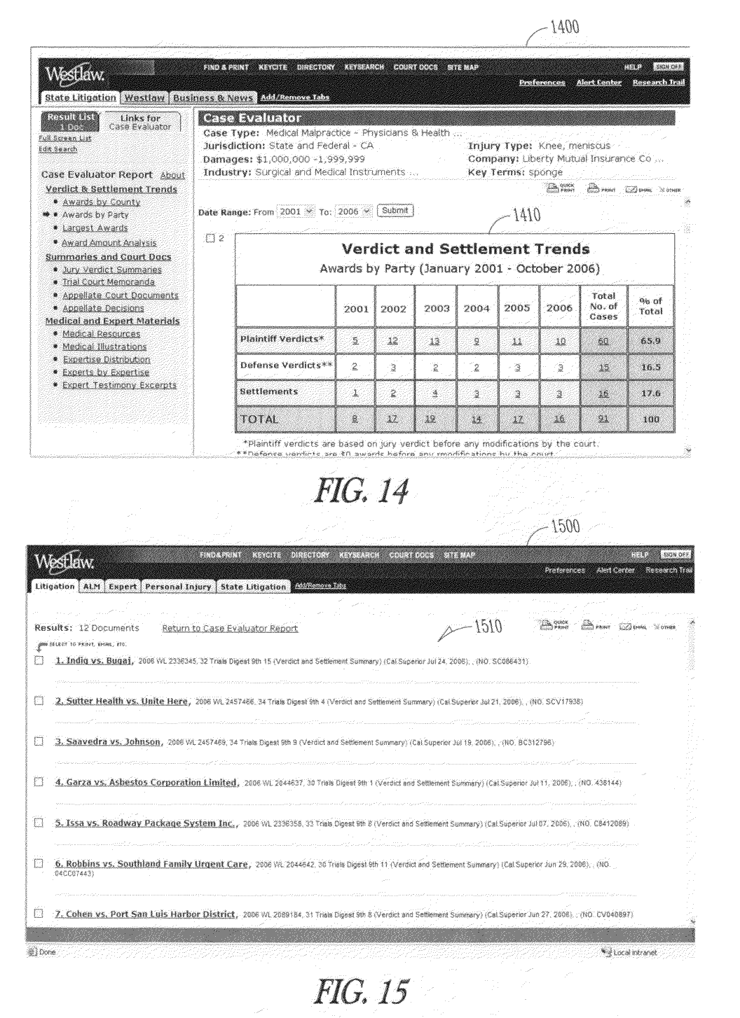

FIG. 14 shows an exemplary Awards by Party report interface 1400. Table 1410 displays the number of plaintiff verdicts, defense verdicts, and settlements for the date range within the parameters selected by user. The table heading states “Verdicts and Settlement Trends, Awards by Party ([Date Range]).” The Awards by Party table includes columns for the type of award, each year covered, the total number of cases for each type of award, and the percent each type of award represents of the total cases. There is a row below the Plaintiff Verdicts, Defense Verdicts, and Settlements rows providing totals for each of the columns. The Plaintiff Verdicts cell contains one asterisk and the Defense Verdict contains two asterisks. Below the Awards by Party box, there are two explanatory notes.

FIG. 15 shows that each number of cases contained in the year columns of table 1410 are hyperlinked such that a cite list 1510 of all of the summaries included in that year displays in a new window 1500. The user can click on the hyperlinked case name from the cite list to view a particular summary (or in some embodiments the entire case and associated news stories, and so forth.).

### Largest Awards Element

FIG. 16 shows an exemplary Largest Awards element interface 1600. Table 1610 displays data on the 10 largest awards across all counties/districts included in the report parameters, sorted by default from highest amount to lowest and secondary sorting by date in reverse chronological order. The table heading states “Verdicts and Settlement Trends, Largest Awards ([Date Range]).” Award values in the Largest Awards table are determined from the fielded award value in the jury verdict summaries and include all types of awards before any modifications by the court. In the event of a tie for the tenth listing, the most recent award is listed. In the event of a tie on amount and date of the tenth award, list all. The Largest Awards table include columns for Amount, Date, County (and/or District), Type, Case Title, and Westlaw Citation. The user may sort by each column in the Largest Awards table except the Westlaw Citation column (ascending or descending) by clicking on the column heading, according to the following rules: a) Sort by date with secondary sort by amount from highest to lowest; b) Sort by county in alpha order with secondary sort by amount from highest to lowest; c) Sort by Type in alpha order with secondary sort by amount from highest to lowest; d) Sort by Case Title in alpha order with secondary sort by amount from highest to lowest. If more than one state is included, the state name follows the county name, separated by a comma. The state may be listed all the time. If there are multiple citations, only the primary citation is listed. The citation is hyperlinked such that clicking on the link displays the full text of the summary in a link viewer if the user has set that option.

### Award Amount Analysis Element

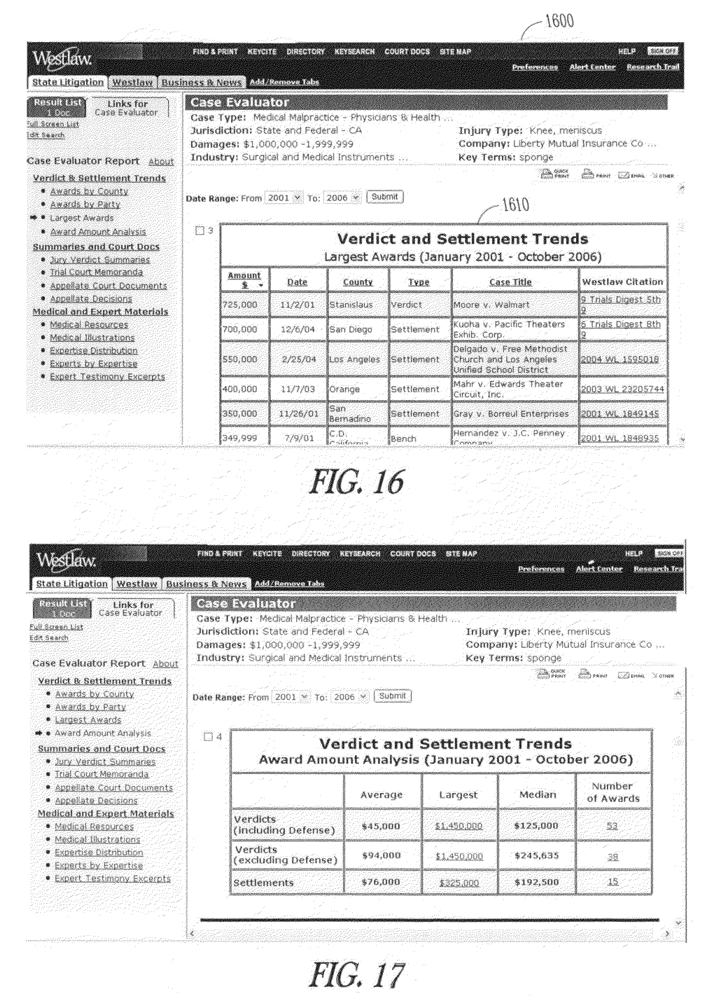

FIG. 17 shows an exemplary Award Amount Analysis element. The table displays the largest, average, and median awards for the date range in the selected data range, as well as the number of each type of award included in the calculations. The table heading states “Verdicts and Settlement Trends, Award Amount Analysis ([Date Range]).” There are columns for largest, average, median and total number of awards and rows for Verdicts that include defense verdicts in the average and median calculations, Verdicts excluding defense verdicts, and Settlements. The award values in the largest award column are hyperlinked such that a result list of all summaries equaling the highest award value display in a new window. Each number of cases contained in the Total Number of Awards column are hyperlinked such that a cite list of all of the summaries included in that total display in a new window. The user can click on the hyperlinked case name from the cite list to view a particular summary.

### Functionality of Summaries and Court Documents Report Component

### Jury Verdict Summaries Element

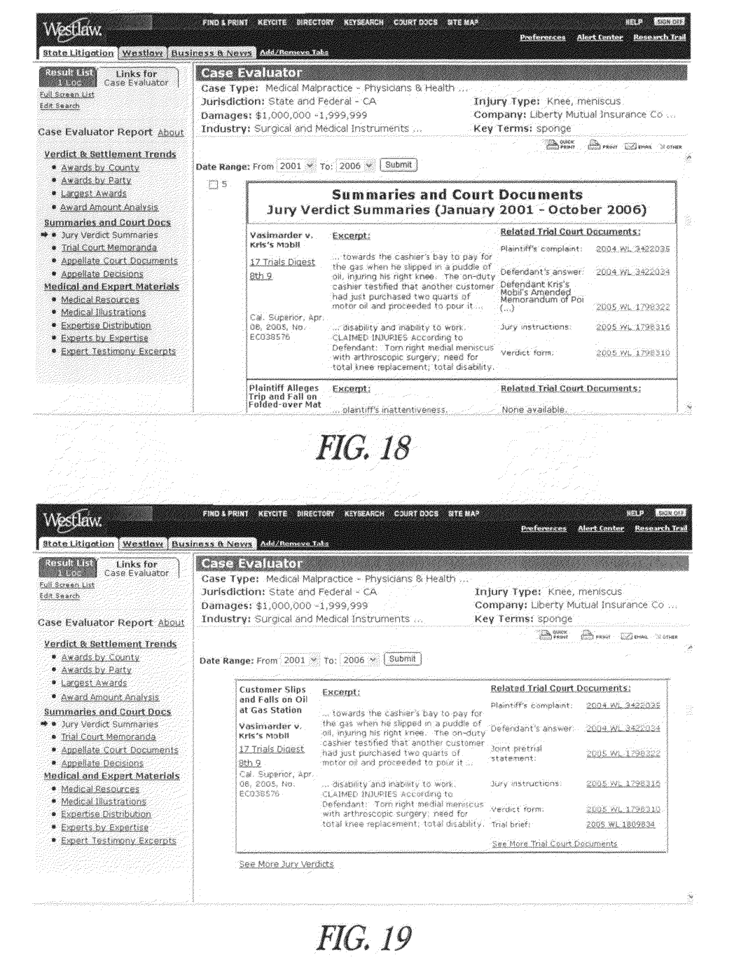

FIG. 18 show excerpts of the three most relevant jury verdict summaries displayed in a chart format. The table heading states “Summaries and Court Documents, Jury Verdict Summaries ([Date Range]).” Relevance ranking is based on the number of occurrences of the selected injury type, case type, and key terms in the jury verdict summaries that are within the report parameters. In the event of a tie for third place in the relevance ranking, the most recent summary is used. In the event of a tie on relevance and date, display all. There are three columns in the table. The first column on the left includes the digest title (West® jury verdicts only), case title, case citation, court, date, and docket number in the left column. In FIG. for jury verdicts summaries other than West® summaries, the case title occupies the first cell of the column; the case citation, court, date, and docket number remains in the same cells as for the West® summaries. The case citation is hyperlinked so that the full text of the jury verdict displays in a new window when the user clicks on the hyperlink. One excerpt from the summary of each jury verdict is displayed in the middle column. Immediately above the excerpts for each jury verdict appears the word “Excerpt:”. The excerpt consists of 30-50 words surrounding occurrences of one or more injury type or key words from the text of the summary. If no injury type or key word is selected for inclusion in the report, or if text searching is not performed to identify the relevant documents, the excerpt consists of the first 30-50 words of the facts section of the jury verdict. The excerpt includes more than one paragraph and the end of a paragraph constitutes the end of that excerpt. In FIG. 19 there is a See More Jury Verdicts link below the three summaries, that enables the user to access a cite list of the top 50 summaries in a new window, based on relevance ranking. The names and citations of Related Court Documents display in the right hand column and include up to 6 court documents. The name of each court document listed is limited to 50 characters. If the name is longer than 50 characters, ellipses [( . . . )] appear at the end of the name. The citation for each court document is hyperlinked. The court documents are listed explicitly in the jury verdict summary or they are listed implicitly at the end of the jury verdict. Immediately above the list of court documents appear the words “Related Trial Court Documents:”.

In the event that more than 6 court documents are available for inclusion, the six are selected in the following priority order: Most recent complaint, most recent answer, trial briefs of both parties, most recent plaintiff's motion, most recent defendant's motion, jury instructions, verdict form, and other motions. If no court documents are available from a case “None available” appear in the blank. The court document citation is hyperlinked such that clicking on the link displays the full text of the document in the link viewer if the user has set that option. If more than 6 court documents are available for inclusion, a “See More Court Documents” link appears at the bottom of the list of court documents and allows the user to access a list of all other court documents related to that summary in a new window.

### Trial Court Memoranda Element

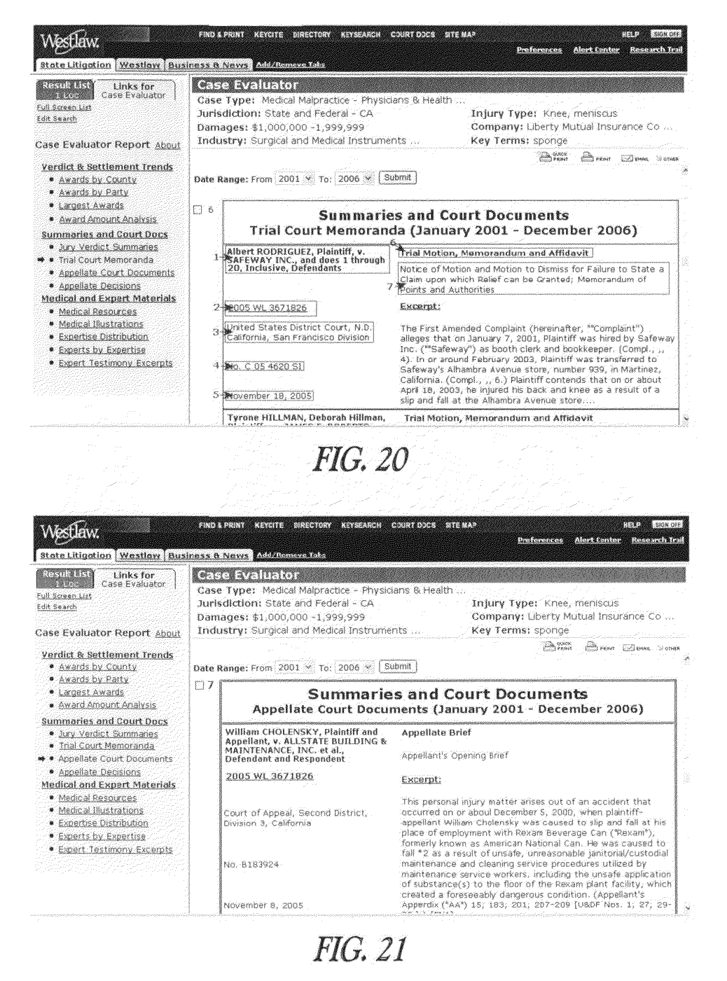

FIG. 20 shows excerpts of the three most relevant trial court motions or memoranda not included as related court documents displayed in a chart format. The table heading states “Summaries and Court Documents, Trial Court Memoranda ([Date Range]).” The table has two columns. Relevance ranking is based on the number of occurrences of the selected injury type, case type, and key terms in the largest Motions multi-base for the jurisdiction chosen in the report parameters. In the event of a tie for third place in the relevance ranking, the most recent document is used. In the even of a tie in relevance and date, then all is displayed. The display includes case title, case citation, court, docket number, and date in the left column. The LBL, DL and an excerpt of the document displays in the right-hand column. Immediately above each excerpt appears the word “Excerpt:”. The excerpt consists of the first 100 words of the text of the court document following the first heading of the document. The citation is hyperlinked such that clicking on the link displays the full text of the document in the link viewer if the user has set that option. There is a See More Trial Memoranda link below the three trial court doc excerpts that enable the user to access a cite list of the top 50 trial court memoranda in a new window, based on relevance ranking.

### Appellate Court Documents Element

FIG. 21 shows excerpts of the three most relevant appellate court documents not included as related court documents displayed in a chart format. The table heading states “Summaries and Court Documents, Appellate Court Documents ([Date Range]).” There are two columns in the table. Relevance ranking is based on the number of occurrences of the selected injury type, case type, and key terms or other jurisdictionally-appropriate database that is within the report parameters. For example, if the user selected Texas state only for the jurisdiction, the database used is TX-BRIEF-ALL. In the event of a tie for third place in the relevance ranking, the most recent document is used. In the event of a tie in relevance and date, all are displayed. The display includes case title, case citation, court, docket number, and date in the left column. The citation is hyperlinked such that clicking on the link displays the full text of the document in the link viewer if the user has set that option. Immediately above each excerpt appears the word “Excerpt:”. The excerpt consists of the first 100 words of the text of the court document. There is a See More Appellate Documents link below the three appellate court doc excerpts that enables the user to access a cite list of the top 50 appellate court docs in a new window, based on relevance ranking.

### Appellate Decisions Element

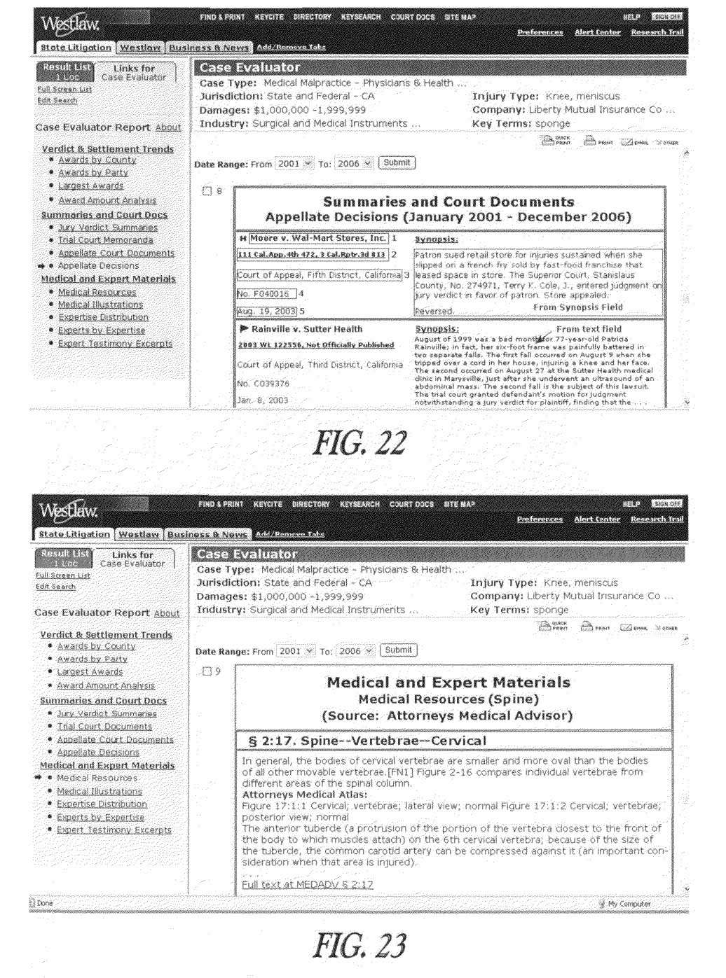

FIG. 22 shows excerpts of the three most relevant appellate decisions displayed in a chart format. The table heading states “Summaries and Court Documents, Appellate Decisions ([Date Range])”. There are two columns in the table. Relevance ranking is based on the number of occurrences of the selected injury type, case type, and key terms in the largest jurisdictional database that is within the report parameters. For example, if the user selected California state only for the jurisdiction, the database used is CA-CS. In the event of a tie for third place in the relevance ranking, the most recent document is used. In the event of a tie in relevance and date, all are displayed. The display includes a clickable KeyCite® flag value, case title, case citation, court, docket number, and date in the left column. The citation is hyperlinked such that clicking on the link displays the full text of the document in a new window. An excerpt of the document and the court action (affirmed, reversed, etc.) displays in the right-hand column. Immediately above each excerpt appears the word “Synopsis:”. The excerpt consists of the case background from the synopsis field or the first 100 words of the text field if no background is available. The court action is pulled from the synopsis field of the caselaw document. If the case does not have a synopsis field, then no court action is displayed. There is a See More Appellate Decisions link below the three appellate court excerpts that enables the user to access a cite list of the top 50 appellate court decisions in a new window, based on relevance ranking.

### Functionality of Medical and Expert Materials Report Component

### Medical Resources Element

In FIG. 23, up to three relevant excerpts from Attorneys Medical Advisor (database MEDADV) are displayed in chart format. The table has a heading of: “Medical and Expert Materials, Medical Resources ([Injury Type]).” The relevant section(s) are predetermined based on a mapping table between medical injury type and MEDADV sections. One relevant section displays for each medical injury type selected for inclusion in the report. In the event that the user has selected multiple medical injury types for inclusion in the report, up to three excerpts are displayed. If no injury type is specified, one generic section of MEDADV is displayed. If more than three specific medical injury types are specified, the three sections that are included are determined by the event count of each selected injury type within jury verdict content, with the three most numerous being displayed. If the injury type is non-medical a message is displayed. The section number and title is displayed in bold in the top line of each section displayed. The full text of the section is included below the section title if the section is no more than two paragraphs long. If the section is more than two paragraphs in length, the first two paragraphs are displayed, followed by ellipses, and a link is provided that, when selected, opens the full text of the section in a link viewer. There is a Table of Contents link below the section text that enables the user to access the Table of Contents of the Attorneys Medical Advisor on Westlaw®. When the user clicks on the Table of Contents link, the standard Table of Contents tree for the Attorneys Medical Advisor displays in a new window. If more than one section is included in the report, the TOC link appears below the last displayed section.

### Medical Illustrations Element

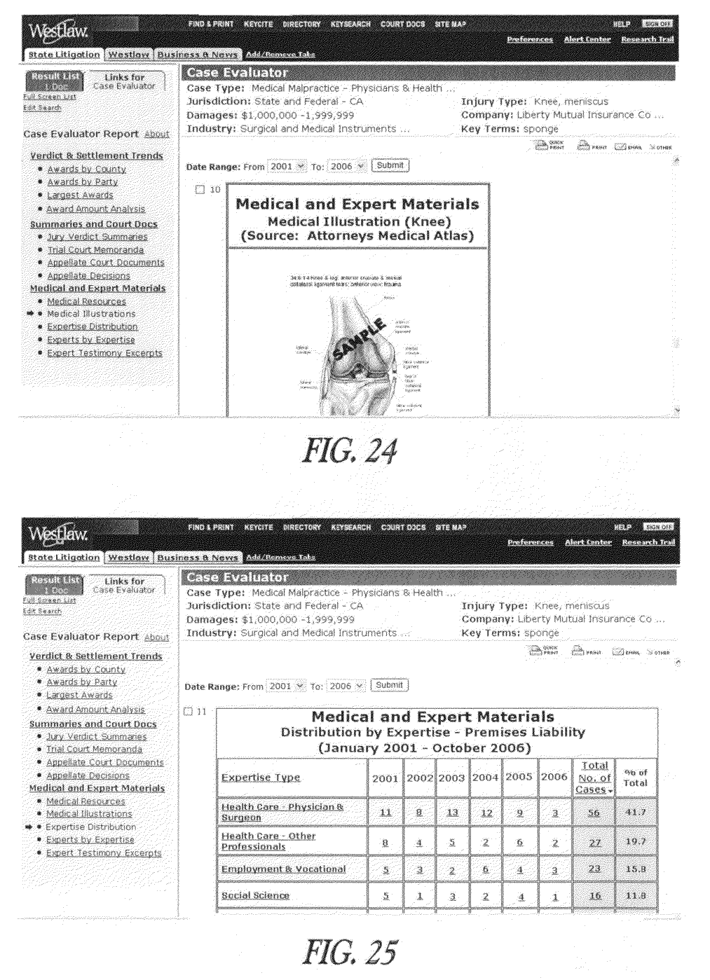

FIG. 24 shows a relevant medical illustration from the Attorneys Medical Atlas (database AMA-ATLAS) displayed in chart format for each injury type selected for inclusion in the report, up to a maximum of three. The table has a heading of: “Medical and Expert Materials, Medical Illustration ([Injury Type]).” The relevant excerpt is predetermined automatically based on a mapping table between medical injury type and AMA-ATLAS section. In the event that the user has selected multiple medical injury types for inclusion in the report, up to three illustrations are displayed. If no injury type is specified, one generic illustration from AMA-ATLAS is displayed.

If more than three specific medical injury types are specified, the three illustrations that are included are determined by the MEDADV sections. If the injury type is non-medical, no result displays for this report element. There is a Table of Contents link-below the illustration that enables the user to access the Table of Contents of the Attorneys Medical Atlas on Westlaw®. When the user clicks on the Table of Contents link, the standard Table of Contents tree for the Attorneys Medical Atlas displays in a new window. If more than one illustration is included in the report, the TOC link appears below the last displayed section. There is a “Download high resolution image” link to a downloadable version of each illustration below each illustration, which links to the document on Westlaw®.

### Expertise Distribution Element

In FIG. 25, a distribution of experts by expertise interface is displayed in chart format. The table has a heading of: “Medical and Expert Materials, Distribution by Expertise—[Case Type] ([Date Range]).” The table is compiled from all experts identified in jury verdict summaries within the report parameters and is sorted according to the expert type taxonomy used for expert documents. The report contains columns from left to right for the expertise type, each 12-month period within the report parameters, Total No. of Cases, and % of Total sorted by default from highest number of cases to lowest and secondary sorting by expertise type in ascending alpha order. The user may sort by Expertise Type or Total No. of Cases (ascending or descending) by clicking on the column heading, according to the following rules: a) Sort by expertise type in alpha order with secondary sort by number of cases from highest to lowest; b) Sort by number of cases with secondary sort by expertise type in ascending alpha order. The list displays the top 10 Expertise types. If more than 10 expertise types have results to display, all remaining results are combined into an “Other” category and are displayed in the last row of the table. The “Other” row always sorts below the rows containing major elements. The % of Total is calculated using the number of cases for each expertise type in which experts were involved and the total number cases for all expertise type in which experts were involved. The expertise type is hyperlinked and is a navigational link to the next element of the report. A listing of experts by area of expertise is displayed in chart format.

### Experts by Expertise Element

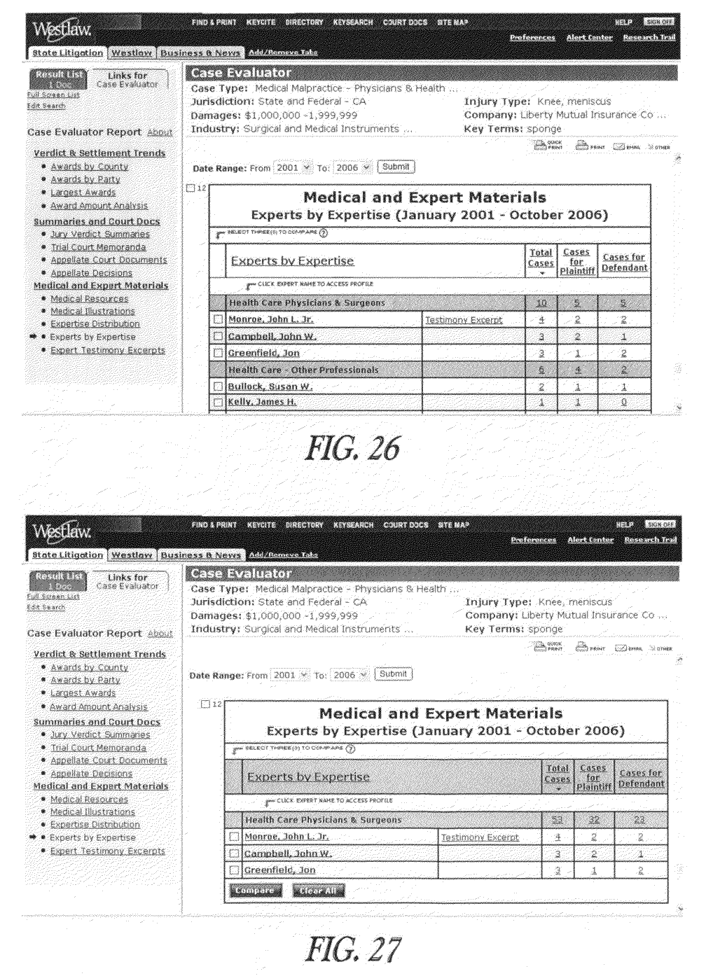

In FIG. 26, the table has a heading of: “Medical and Expert Materials, Experts by Expertise—[Area of Expertise] [(Date Range)].” The experts are listed by name under the subheading of their expertise type, sorted by default in descending rank by the number of cases in which they have been involved with a secondary sort by name in ascending alpha order. The user may sort by each column in the Experts by Expertise table (ascending or descending) by clicking on the column heading, according to the following rules: a) Sort by Expertise type in alpha order, with experts sorted in ascending alpha order within each expertise type and with secondary sort by number of cases from highest to lowest; b) Sort by total number of cases for each expertise type with secondary sort by expertise type in ascending alpha order; c) Sort by total cases for plaintiff for each expertise type with secondary sort by expertise type in ascending alpha order; d) Sort by total cases for defendant for each expertise type with secondary sort by expertise type in ascending alpha order. Checkboxes to the left of each expert's name allow the user to select three experts to compare side-by-side.

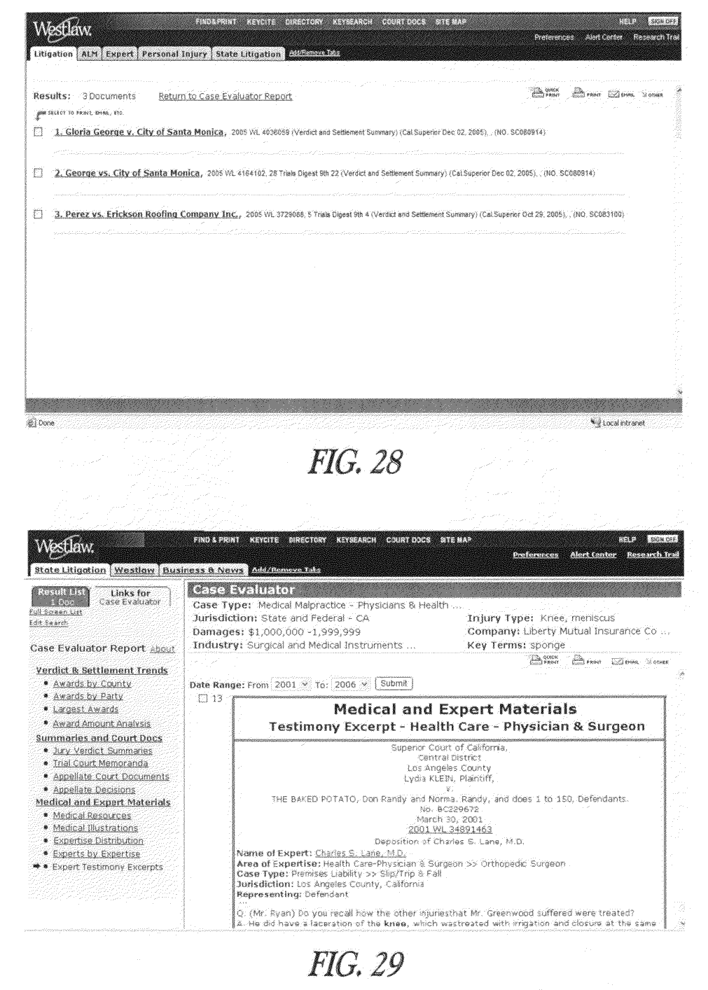

In FIG. 29, there are radio buttons below the table for “Compare” and “Clear” that allow the user to generate the comparison report. When the user clicks on “Compare”, the comparison feature of the Expert Investigation Tool is launched in a new window. A warning screen displays before the Expert Investigation Tool report generates indicating that this is a chargeable event and to instruct the user to use the Back button to return to the Case Evaluator Report. The expert's name is hyperlinked to Profiler, which opens in a new window. For the top three experts with expert testimony available in EW-DOCS in each expertise type, a navigational link is provided in the column immediately to the right of the expert's name to an excerpt of their testimony in the next element of the report. In some embodiments, the excerpt is provided not only in transcribed form, but also in audio and video form. Some embodiment may also allow experts to store promotional text, audio, or video images in association with their testimony to effectively capture new business leads. In FIG. 28, there are columns on the right hand side of the table for the total number of jury verdicts in which each expert is involved, the number in which he or she represented the plaintiff and the number in which he or she represented the defendant. The user clicks on the hyperlinked number to view a cite list of the actual jury verdict summaries. The total cases and the number of plaintiff or defense cases are hyperlinked such that the user may access a cite list of all jury verdicts included in that number in a new window.

### Expert Testimony Excerpts Element

In FIG. 29, the most relevant excerpts from the expert document of the top three experts in each expertise type are displayed in chart format. The table has a heading of: “Medical and Expert Materials, Testimony Excerpt—[Area of Expertise].” The expert testimony excerpt is determined by relevance ranking of the number of occurrences of each injury type, case type, and key words within the expert document. At the top center of each excerpt the case name, court, document type, and testimony date is listed. The testimony citation appears below the date line and above the document head and be linked so that the user can click on the link to access the entire testimony document in a link viewer if the user has set that option. Each testimony excerpt consists of 100 words surrounding the first occurrence of a key word or injury type. If an expert has more than one expert testimony document available, only an excerpt of the most recent document displays.

### Print, Download, Fax and Email Functionality

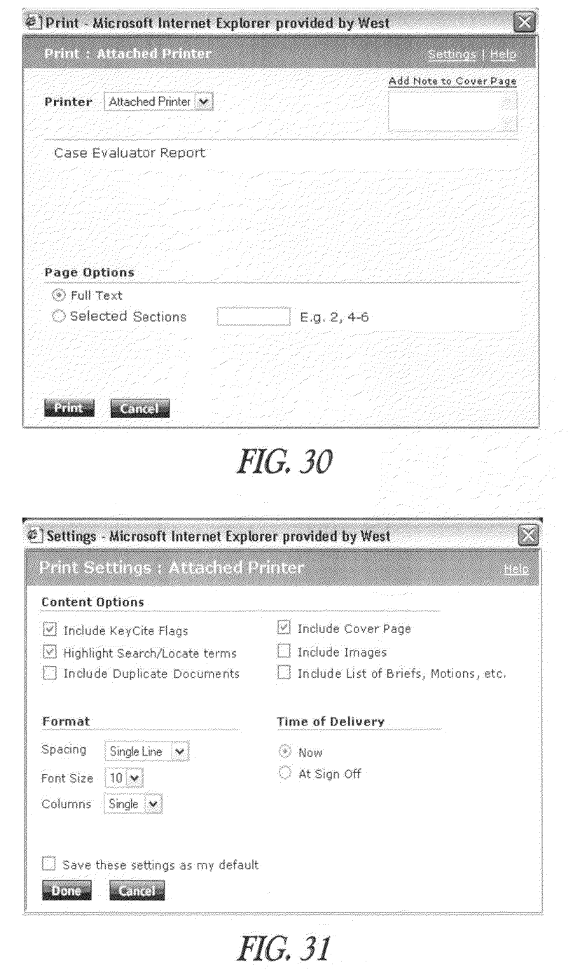

FIG. 30 shows the user choosing the Print icon. A dialog box titled “Print: Attached Printer” and a drop down menu next to the word “Printer” at the top of the print dialog box that displays two print destination options: Attached Printer (default) and STP. There are two page options in the dialog box: Full Text and Selected Sections, with Full Text being the default unless the user previously selected certain report elements. There is a white Settings link in the top right corner of the dialog box that displays a separate dialog box titled “Print Settings: Attached Printer.”

FIG. 31 shows Format and Time of Delivery sections are located in the Print Settings box. The Format section allows the user to select spacing, font size and columns. The user can also choose to save the settings as the default.

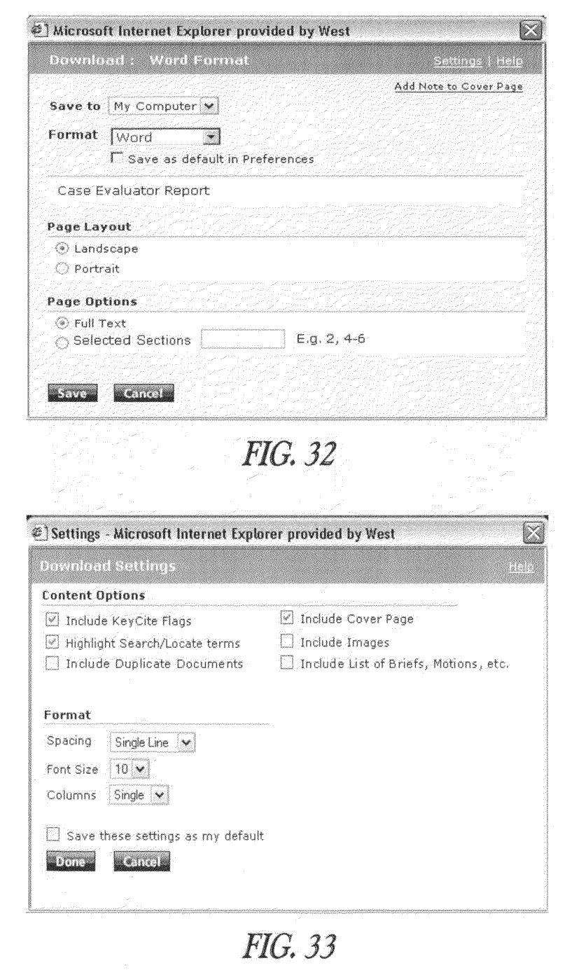

FIG. 32 shows the user selecting the Other icon and selects Download from the drop down menu, a dialog box appears. The title of the dialog box is dependant on the user's download preferences. For example, if the user's download format is set to Word, the title of the dialog box is “Download: Word Format.” There is a drop down menu next to the words “Save to” at the top of the Download dialog box that has two options: My Computer (default) and Westlaw®. There is a drop down menu below “Save to” for “Format” that default to the user's download format preference and contains the other following options: HTML, Word, WordPerfect, PDF, and Plain Text. There are two page options in the dialog box: Full Text and Selected Sections, with Full Text being the default unless the user previously selected certain report elements. If the user's download format is set to Word, WordPerfect, or PDF, a Page Layout section appears in the dialog box and has the following options: Landscape and Portrait—with Landscape being the default. If the download format is set to any other option, the Page Layout section appears and the layout defaults to portrait. There is a white Settings link in the top right corner of the dialog box that displays a separate dialog box titled “Download Settings.”

FIG. 33 shows a Format section which allows the user to select spacing, font size and columns. The user can also choose to save the settings as the default.

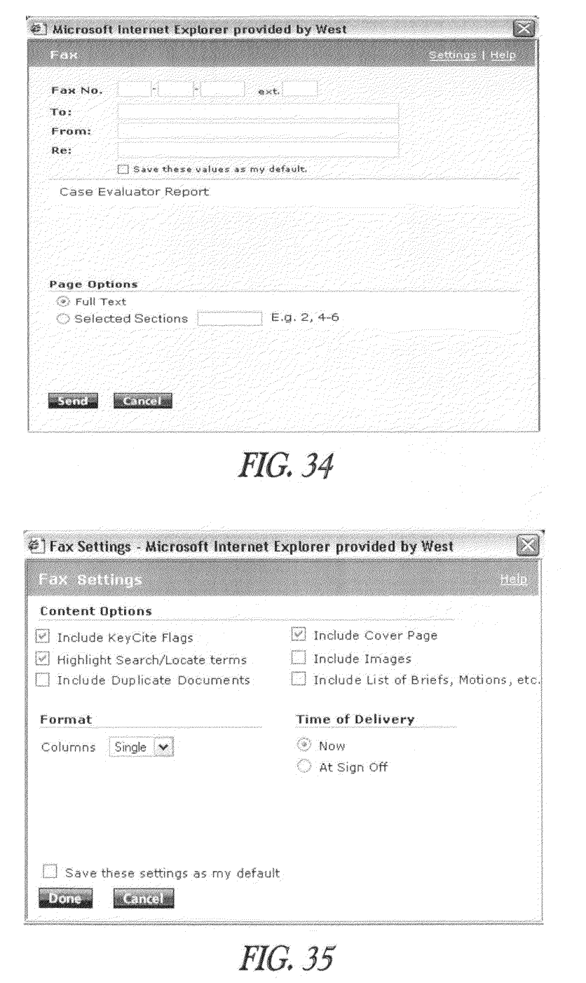

FIG. 34 shows a user choosing the Other icon and selects Fax from the drop down menu, a dialog box titled “Fax” and fields at the top of the Fax dialog box for fax number, to, from, and re. There are two page options in the dialog box: Full Text and Selected Sections, with Full Text being the default unless the user previously selected certain report elements. There is a white Settings link in the top right corner of the dialog box that displays a separate dialog box titled “Fax Settings.”

FIG. 35 shows a format section in the Fax Settings box that has a drop down menu next to the word Columns. The Columns drop down menu defaults to single and remains single for the Case Evaluator report even if the user selects dual. There is also a Time of Delivery section in the Fax Settings box.

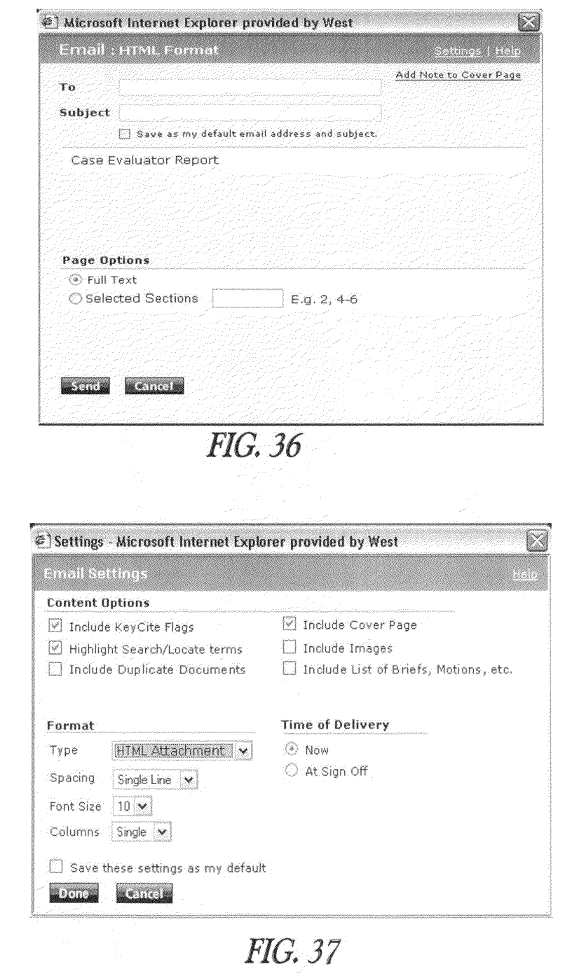

FIG. 36 shows a user selecting the Email icon. The title of the dialog box is dependant on the users e-mail preferences. For example, if the user's e-mail format is set to HTML, then the title of the dialog box is “Email: HTML Format.” There are fields at the top of the Email dialog box for To and Subject. There are two page options in the dialog box: Full Text and Selected Sections, with Full Text being the default unless the user previously selected certain report elements. There is a white Settings link in the top right corner of the dialog box that displays a separate dialog box titled “Email Settings.”

FIG. 37 shows a format section in the Email Settings box that has a drop down menu next to the word Type. The Type drop down menu defaults to the user's e-mail format preferences and has the following options: HTML Attachment, Word Attachment, WordPerfect Attachment., PDF Attachment, HTML Inline, Plain Text Attachment, and Plain Text Inline. There is also a Time of Delivery section in the Email Settings box. If an e-mail exceeds 5 MB, the system still attempts to send the e-mail but the user receives an accompanying message that the e-mail may be too large with a prompt to use download or ATP to deliver the file.

### Exemplary Information-Retrieval System

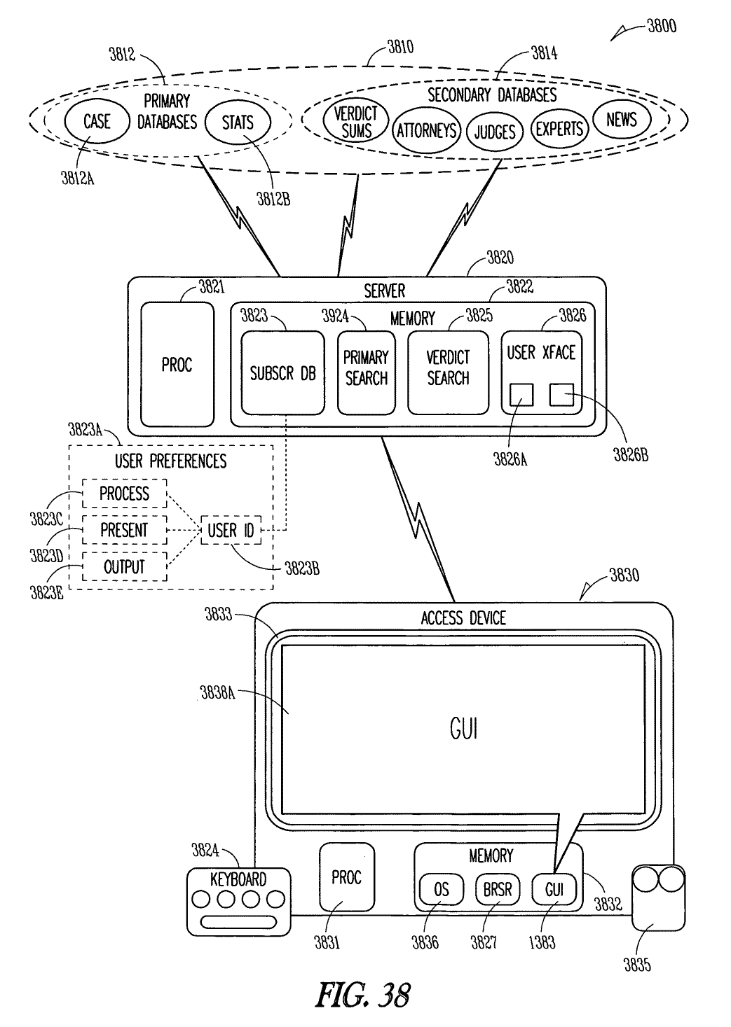

FIG. 38 shows an exemplary online information-retrieval system 3800, which may be adapted to incorporate the capabilities, functions, methods, interfaces, and so forth described above. System 100 includes one or more databases 110, one or more servers 120, and one or more access devices 130.

Databases 3810 includes a set of primary databases 3812 and a set of second databases 3814. Primary databases 3812, in the exemplary embodiment, include a caselaw database 3812A and a statutes databases 3812B, which respectively include judicial opinions and statutes from one or more local, state, federal, and/or international jurisdictions. Secondary databases 3814, provide attorney, judge, law firm, expert witness, product, and corporate profiles. Each corporate and expert witness profile includes one or more industry classification codes or indicators. In some embodiments, the caselaw documents are logically associated via a data structure with documents or profiles in databases 3814. Other embodiments may include non-legal databases that include financial, scientific, or health-care information. Still other embodiments provide public or private databases, such as those made available through INFOTRAC.

Databases 3810, which take the exemplary form of one or more electronic, magnetic, or optical data-storage devices, include or are otherwise associated with respective indices (not shown). Each of the indices includes terms and phrases in association with corresponding document addresses, identifiers, and other conventional information. Databases 3810 are coupled or couplable via a wireless or wireline communications network, such as a local-, wide-, private-, or virtual-private network, to server 3820.

Server 3820, which is generally representative of one or more servers for serving data in the form of webpages or other markup language forms with associated applets, ActiveX controls, remote-invocation objects, or other related software and data structures to service clients of various “thicknesses.” More particularly, server 3820 includes a processor module 3821, a memory module 3822, a subscriber database 3823, a primary search module 3824, a verdict search (case evaluator) module 3825, and a user-interface module 3826.

Processor module 3821 includes one or more local or distributed processors, controllers, or virtual machines. In the exemplary embodiment, processor module 3821 assumes any convenient or desirable form.

Memory module 3822, which takes the exemplary form of one or more electronic, magnetic, or optical data-storage devices, stores subscriber database 3823, primary search module 3824, verdict search module 3825, and user-interface module 3826.

Subscriber database 3823 includes subscriber-related data for controlling, administering, and managing pay-as-you-go or subscription-based access of databases 3810. In the exemplary embodiment, subscriber database 3823 includes one or more preference data structures, of which data structure 3823A is representative. Data structure 3823A includes a customer or user identifier portion 3823B, which is logically associated with one or more verdict research (or case evaluator) preferences, such as preferences 3823C, 3823D, and 3823E. Preference 3823C includes a default value governing whether case evaluator functionality as described herein is enabled or disabled. Preference 3823D includes a default value governing presentation of case evaluator report interfaces. Preference 3823E includes a default value governing specific case evaluator related time frames; preferences related to jurisdiction, case type, damages, company, or industry; preferences related to performance of automated alert functions, such as alert intervals or other conditions; preferences related to access to litigation exhibits. (In the absence of a temporary user override, for example, an override during a particular query or session, the default value for trend reporting govern.)

Primary search module 3824 includes one or more search engines and related user-interface components, for receiving and processing user queries against one or more of databases 3810. In the exemplary embodiment, one or more search engines associated with search module 3824 provide Boolean, tf-idf, natural-language search capabilities.

Verdict search (or case evaluator) module 3825 includes one or more search engines for receiving and processing queries against one or more of databases 3814. Some embodiments charge a separate or additional fee for searching and/or accessing documents from the secondary databases.

User-interface module 3826 includes machine readable and/or executable instruction sets for wholly or partly defining web-based user interfaces, such as search interface 3826A and results interface 3826B, over a wireless or wireline communications network on one or more accesses devices, such as access device 3830.

Access device 3830 is generally representative of one or more access devices. In the exemplary embodiment, access device 3830 takes the form of a personal computer, workstation, personal digital assistant, mobile telephone, or any other device capable of providing an effective user interface with a server or database. Specifically, access device 3830 includes a processor module 3831 one or more processors (or processing circuits) 3831, a memory 3832, a display 3833, a keyboard 3834, and a graphical pointer or selector 3835.

Processor module 3831 includes one or more processors, processing circuits, or controllers. In the exemplary embodiment, processor module 3831 takes any convenient or desirable form. Coupled to processor module 3831 is memory 3832.

Memory 3832 stores code (machine-readable or executable instructions) for an operating system 3836, a browser 3837, and a graphical user interface (GUI) 3838. In the exemplary embodiment, operating system 136 takes the form of a version of the Microsoft Windows operating system, and browser 3837 takes the form of a version of Microsoft Internet Explorer. Operating system 3836 and browser 3837 not only receive inputs from keyboard 3834 and selector 3835, but also support rendering of GUI 3838 on display 3833. Upon rendering, GUI 3838 presents data in association with one or more interactive control features (or user-interface elements). (The exemplary embodiment defines one or more portions of interface 3838 using applets or other programmatic objects or structures from server 3820 to implement the interfaces shown above or elsewhere in this description.)

### CONCLUSION

The embodiments described above and in the claims are intended only to illustrate and teach one or more ways of practicing or implementing the present invention, not to restrict its breadth or scope. The actual scope of the invention, which embraces all ways of practicing or implementing the teachings of the invention, is defined only by the issued claims and their equivalents.

What is claimed is:

1. An online legal research system comprising:
a server for an online legal-research provider, the server coupled to one or more databases containing law-related documents and related verdict data;
at least one client access device coupled to the server via the Internet and having a display for presenting a graphical user interface including one or more user-interface elements at least partially configured or defined by the server, wherein one or more of the elements allows the user to define and submit one or more legal-research queries for verdict information by sequentially accessing and selecting from a set of two or more listings, wherein each listing is associated with a fact-pattern parameter; and
means associated with the server for returning search results to the one client access device in response to the received query, wherein the search results include case law documents and related verdict data, wherein the verdict data is separated from the case law documents to facilitate review of the verdict data.

2. A method of operating an online legal research system, comprising:
outputting interface definition data to a client access device over a computer network, wherein the interface definition data defines in conjunction with the operating system of the client access device a graphical user interface including one or more user-interface elements that allows a user to define and submit a query for verdict information by sequentially accessing and selecting from a set of two or more listings, wherein each listing is associated with a fact-pattern parameter; and
receiving the query at the online legal research system; and
in response to the received query outputting verdict information to the client access device.
